(19) United States
(12) Patent Application Publication
(10) Pub. No.: US 2026/0045737 A1
(43) Pub. Date: Feb. 12, 2026

(54) Self-locking Portable Power Distributor Breadboards

(71) Applicant: CODEBENDER R&D HELLAS MONOPROSOPI IKE, Patras (GR)

(72) Inventor: Vasileios Georgitzikis, Patras (GR)

(73) Assignee: CODEBENDER R&D HELLAS MONOPROSOPI IKE, Patras (GR)

(21) Appl. No.: 19/102,392

(22) PCT Filed: May 16, 2023
(86) PCT No.: PCT/EP2023/063195

§ 371 Date: Feb. 8, 2025

(30) Foreign Application Priority Data
Aug. 11, 2022 (GR) GR20220100679

(51) Int. Cl. H01R 13/629

(52) U.S. Cl. CPC H01R 13/629

(57) ABSTRACT

A self-locking portable power distributor for breadboards has a power input, and a power output with two conductive lines, configured for supplying voltage and ground to at least one breadboard. The distributor includes at least one three-dimensional connection element located on a distributor first outer surface such that the distributor three-dimensional connection element is shaped and dimensioned to be compatible with at least one three-dimensional connection element of the breadboard. The breadboard three-dimensional connection element may be located on a breadboard first outer surface disposed substantially perpendicular to a breadboard second outer surface. The second outer surface of the breadboard may carry at least one electronic component terminal socket. The distributor three-dimensional connection element may be configured for engaging with the breadboard three-dimensional connection element for allowing side-to-side connection of the distributor to the breadboard with respect to the at least one electronic component terminal socket.

### REFERENCE TO RELATED APPLICATIONS

This application claims priority to and the benefit of GR20220100679, filed on Aug. 11, 2022.

### BACKGROUND

State of the Art: Experimental Electronic Circuit Layout Devices (EECLDs) or otherwise devices for rapid development and testing of electronic circuits, known as breadboards, are widely used for easy, fast, inexpensive and reversibly lay outing and testing of electronic circuits. EECLDs have been available for several decades in different forms, dimensions and complexity.

In its general form, an EECLD consists of one or more two-dimensional arrays, where each cell of the array is a socket dimensioned to fit and largely secure a metal terminal of an electronic component (e.g. resistor, capacitor, diode, integrated circuit, etc.) in the socket. The terminal is in the form of a wire or metal leg with a standardized cross-section or maximum transverse dimension which is approximately equal to the cross-section or maximum transverse dimension of each cell-socket of the EECLD.

EECLDs also contain voltage supply lines which lines are selectively connected to rows or columns of the panel in order to supply voltage to the electronic components connected to the panel. Correspondingly, in the case of connecting integrated circuits (microchips) to the board, in addition to the voltage supply, the cells of the board can be used to implement a data bus or a control bus. A voltage source, or a power supply is usually used to power an EECLD, which is usually a device independent of the EECLD to which it is connected via two or more removable cables, while in other cases, an integrated device is used which includes one or more EECLDs and a power supply which are connected via fixed-non-removable cables. Both the power supply and the complete device have a large volume and weight compared to the EECLD as they include a number of circuits, such as a transformer and voltage rectifier, a system for protecting electronic circuits from overvoltage, etc.

The volume and weight of these devices make their use and transport difficult. Especially the easy transfer of the EECLD is important as in many cases it is necessary to connect electronic elements to the EECLD in order to verify their functional status or damage. This process very often needs to be done in the field rather than in the laboratory, which requires light and unbulky EECLDs and power supplies or integrated devices. Such lightweight integrated devices with EECLDs are not common despite the fact that some are known in the art. However, all known lightweight integrated devices with EECLDs are of the type of custom devices, in the sense that each can accommodate a specific type (i.e. dimensioned) of breadboard and is not versatile to allow using any type of breadboard or more than one breadboard. In addition, such known devices also have the limitation of simply holding a breadboard but securely locking it into place, which in turn creates problems of safely and easily using the integrated device in the field.

At the same time there are examples of EECLDs which are powered by batteries to achieve easier use in the field, but even in this case there are problems and disadvantages. For example, as the batteries are easily depleted, they require frequent replacement or recharging, thus creating the additional logistics problem that the EECLD user must bring with him to the field at least one spare battery and/or charge the EECLD battery before each use. Furthermore, since the batteries used are usually bulky and heavy, they present similar disadvantages and limitations as the above-mentioned integrated devices.

In addition to the above problems, in the case of using an EECLD with an external-independent power supply or battery, both the independent power supply and the battery are connected to the EECLD via removable cables, which cables make it difficult to use the EECLD in the field, as the user must additionally handle the removable cables as well as the mains power supply cable.

### SUMMARY

Problem Definition: A portable power distribution device is necessary which facilitates the use of EECLDs in the field and elsewhere and which device is suitable for use with any type of EECLD, easy to use and easy to manufacture.

### Proposed Solution

### Self-locking Portable Power Distributor for EECLDs

The present invention relates to a Self-Locking Power Distributor for EECLDs (SLPDE) or Power Distribution Unit (PDI). This SLPDE can be implemented in different ways as shown below in implementation examples. The common features of all exemplary embodiments are the use of a Universal Serial Bus (USB) connector of any version (e.g. type B, C, micro, etc.) to easily provide power from any device equipped with a USB connector of any version and type, as well as, 3D morphological characteristics for the locking of the SLPDE to the EECLD in a side-by-side mode with respect to the electronic component terminal sockets.

The present invention also relates to a method of providing power to SLPDEs and to EECLDs with integrated SLPDEs.

In one aspect, a self-locking portable power distributor for breadboards includes a power input, and a power output with two conductive lines, configured for supplying voltage and ground to at least one breadboard, where the distributor includes at least one three-dimensional connection element located on a first outer surface of the distributor such that the three-dimensional connection element of the distributor is shaped and dimensioned to be compatible with at least one three-dimensional connection element of the breadboard. The three-dimensional connection element of the breadboard may be located on a first outer surface of the breadboard, where the first outer surface of the breadboard is substantially perpendicular to a second outer surface of the breadboard. The second outer surface of the breadboard may carry at least one electronic component terminal socket. The at least one three-dimensional connection element of the distributor may be configured for engaging with the at least one three-dimensional connection element of the breadboard for allowing side-to-side connection of the distributor to the breadboard with respect to the at least one electronic component terminal socket.

The power input may include a Universal Serial Bus (USB) connector, located either (a) on a second external surface of the distributor parallel to the first external surface of the distributor, or (b) on a third external surface of the distributor perpendicular to the first and the second outer surfaces of the distributor and be configured for being perpendicular to the second outer surface of the breadboard when the breadboard is secured to the distributor. The USB connector may be configured for providing voltage and ground to the output of the distributor and for receiving voltage and ground from an external power supply device.

The USB connector may be selected between type B, C, and micro. The at least one three-dimensional connection element of the distributor may include a projection and/or a recess type element. The at least one three-dimensional connection element of the distributor may include a square, parallelogram, triangular, prismatic, cylindrical and/or prismatic cross-section. The Self-locking portable power distributor for breadboards may additionally include at least one of: at least one voltage regulator; at least one voltage selector; a dimmer switch; a voltmeter; an ammeter; and a battery. The USB connector may include one or more USB connectors. The Self-locking portable power distributor for breadboards may include a battery and/or at least one USB connector.

Another aspect includes a method for supplying power to at least one breadboard including the following steps: securing a self-locking portable power distributor according to the features described above, to at least one breadboard, by locking at least one three-dimensional connection element of the distributor with at least one three-dimensional connection element of the at least one breadboard, where the at least one three-dimensional connection element of the distributor is compatible with the at least one three-dimensional connection element of the at least one breadboard; connecting the power output of the distributor to the at least one breadboard via a first cable for supplying a voltage and via a second cable for providing a ground from the distributor to the at least one breadboard; and connecting the power input of the distributor, via the USB type connector of the distributor, to a USB connector of an external power supply device for providing a first voltage and ground from the external power supply device to the distributor.

The method may also include selecting at least one second voltage for supplying to the at least one breadboard by using (a) at least one voltage selector of the distributor, where the at least one voltage selector selects the at least second voltage and routes it to the output of the distributor, and where the at least second voltage is produced by at least one voltage regulator of the distributor, or (b) at least one voltage regulator the output of which is directly connected to the output of the distributor, or (c) a USB Power Delivery protocol, which protocol allows the distributor to receive the second voltage from the external power supply device and distribute it to at least one power output of the distributor, or (d) a USB Power Delivery protocol, which protocol allows the distributor to receive the second voltage from the external power supply device and generate at least one third voltage and distribute the at least one third voltage to at least one power output of the distributor.

A further aspect includes use of a self-locking portable power distributor for breadboards as described above for supplying at least one voltage to at least one breadboard according to the any of the methods described above.

### DESCRIPTION

### EECLDs according to the State of the Art

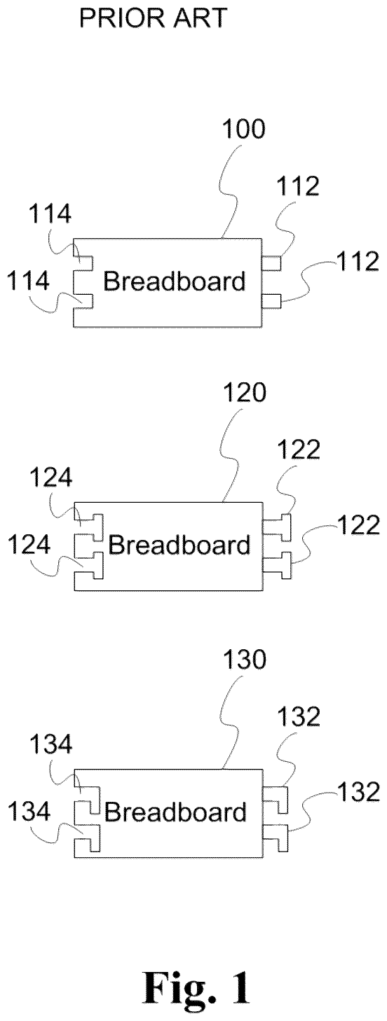

FIG. 1 shows examples of EECLDs of the State of the Art. A first EECLD (100) has a rectangular (or square) shape and includes on an external surface one or more panels (not shown) whose cells are sockets for terminals of electronic components. The first EECLD (100) includes on one of its external surfaces, essentially perpendicular to the surface carrying the one or more panels, one or more three-dimensional connection elements. Each three-dimensional connection element is of a protrusion type (112) (e.g. square, parallelogram, triangular, prismatic, cylindrical, elliptical, or other cross-section). On another outer surface thereof, parallel to the outer surface bearing the three-dimensional protrusion-type connection element (112), the EECLD (100) includes one or more three-dimensional recess-type connection elements (114), each of which is shaped and dimensioned to allow insertion and locking of one of the three-dimensional protrusion-type connecting elements (112). The use of three-dimensional protrusion (112) and recess (114) type connectors allow two or more PCBs (100) to be locked together to create a larger panel with sockets for electronic component terminals.

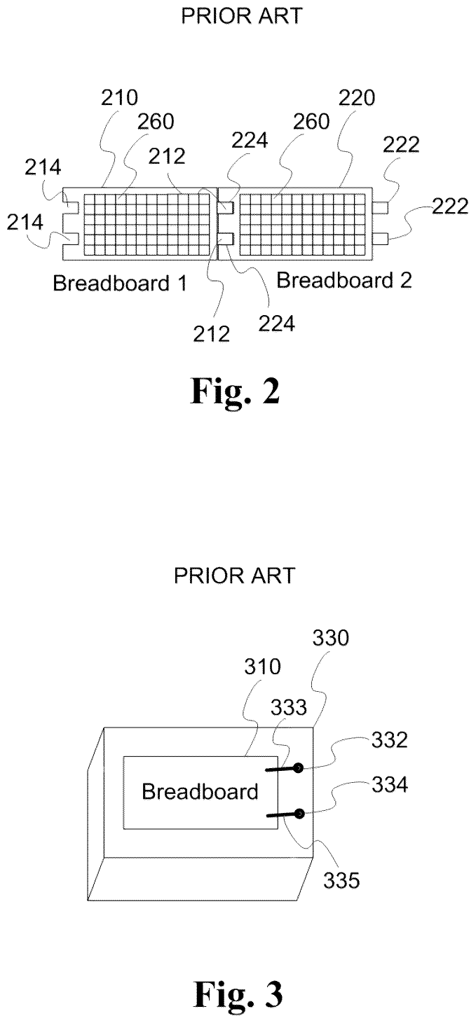

FIG. 2 shows an example of connecting two EECLDs according to the state of the art. A first EECLD (210) connects and secures one or more three-dimensional protrusion-type connecting elements (212), with one or more three-dimensional recess-type connecting elements (224) of a second EECLD (220). The EECLDs (210), (220) are of the type shown in FIG. 1 and each has three-dimensional connection elements of both types, i.e. protrusion (222) and recess (224) types. Each of the EECLD includes a panel whose cells (260) are sockets for terminals of electronic components.

FIG. 1 also shows a second PCB (120) which is rectangular (or square) in shape and includes one or more panels (not shown) whose cells are sockets for electronic component terminals. The second EECLD (120) includes on one of its external surfaces, substantially perpendicular to the surface carrying the one or more panels, one or more three-dimensional connection elements. Each three-dimensional connection element is of a protrusion type (122) (e.g. “T” shaped). On another outer surface thereof, parallel to the outer surface bearing the three-dimensional projection-type connection element (122), the EECLD (120) includes one or more three-dimensional recess-type connection elements (124), each of which is shaped and dimensioned to allow insertion and locking of one of the three-dimensional protrusion-type connecting elements (122). The use of the three-dimensional protrusion (122) and recess (124) type connectors allow two or more PCBs (120) to be locked together to create a larger board with sockets for electronic component terminals. The connection of two or more EECLDs (120) is done respectively as shown in FIG. 2.

FIG. 1 also shows a third PCB (130) which has a rectangular (or square) shape and includes one or more panels (not shown) whose cells are receptacles for terminals of electronic components. The third EECLD (130) includes on one of its external surfaces, substantially perpendicular to the surface carrying the one or more panels, one or more three-dimensional connecting elements. Each three-dimensional connection element is of a protrusion (132) type (e.g. “Γ” or hook shaped). On another outer surface thereof, parallel to the outer surface bearing the three-dimensional projection-type connection element (132), the EECLD (130) includes one or more three-dimensional recess-type connection elements (134), each of which is shaped and dimensioned to allow insertion and locking of one of the three-dimensional protrusion-type connecting elements (132). The use of three-dimensional protrusion (132) and recess (134) type connectors allow two or more EECLDs (130) to be locked together to create a larger panel with receptacles for electronic component terminals. The connection of two or more EECLDs (130) is done respectively as illustrated in FIG. 2.

In alternative embodiments of the EECLD (100, 120, 130) the three-dimensional connection elements may have any other shape.

FIG. 3 shows an integrated device according to the prior art, which device includes one or more EECLD and a power supply. The integrated device (330) is in the form of a box inside which the electronic circuits of the power supply are included. An external surface of the integrated device (330) carries a PCB (310) which is connected to the voltage output and ground of the power supply, usually via removable cables which are connected to receptacles (332), (334), respectively. Alternatively, the EECLD (310) is permanently connected to the voltage output and ground of the power supply via fixed cables or wires. The PCB is simply placed, not securely locked in a depression of the upper surface of the integrated device (330).

The integrated device (330) includes in its power supply a variety of electronic circuits, including an Alternating Current (AC) transformer and rectifier so that it can be connected directly to a Direct Current (DC) power outlet. In an alternative embodiment, the integrated device (330) includes a battery to provide power. In another alternative embodiment, the integrated device (330) includes an AC transformer and rectifier, as well as, a battery for use both in areas with easy access to an electrical outlet, as well as, in areas without an electrical outlet or during power outages (e.g. due to damage). The integrated device (330), due to the transformer or the battery it includes, has a large volume and weight compared to the EECLD (330) and is, therefore, difficult to transport and use but also complicated and expensive to manufacture.

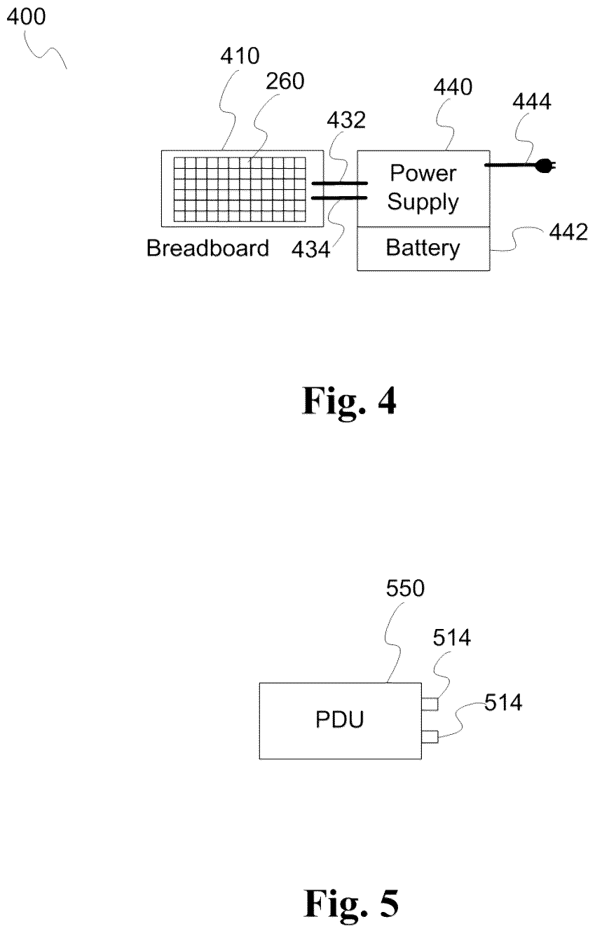

FIG. 4 shows a system consisting of an EECLD connected to an independent power supply according to the prior art. The system (400) includes a power supply (440) which is connected to an electrical outlet via a cable and plug (444) while alternatively or optionally includes a battery (442). Power supply (440) is also connected, via detachable cables (432), (434) to EECLD (410) for power supply. The power supply (440) has a large volume and weight compared to the EECLD (410) and is, therefore, difficult to transport and use but also complicated and expensive to manufacture. At the same time as the power supply (440) and EECLD (410) are independent devices and are loosely connected via the detachable cables (432), (434) and therefore are difficult to handle in the field since the user has to handle two devices. They are also prone to breakage of cables which can create additional problems. The power supply (440) has a large volume and weight compared to the EECLD (410) and is therefore difficult to transport and use but also complicated and expensive to manufacture. At the same time as the power supply (440) and EECLD (410) are independent devices and are loosely connected via the detachable cables (432), (434) are difficult to handle in the field since the user has to handle two devices and are also prone to breakage of cables which can create additional problems.

In other prior art EECLD examples, power supplies are used which include a USB port. In these EECLD examples the power supplies used are stand-alone devices which are connected via cables to the EECLD and are therefore difficult to use in the field. Likewise, other prior art examples of EECLD use power supplies that include a USB port, which is positioned in a way that interferes with the cell array (260) and the electronics connected to the cells. This creates problems due to the limited space of the device, but also increases its volume, making it more difficult to use, especially in the field.

### Innovative Problem Solution—Self-Locking Power Distributor for EECLDs

FIG. 5 shows an example of the implementation of a power distribution unit according to the present innovative solution. The Power Distribution Unit (PDU) (550) is in the form of a box of rectangular or square cross-section and carries on an external surface one or more three-dimensional connection elements (514) shaped and dimensioned so that they can be inserted and locked in the corresponding one or more indents (114), (124), (134) of EECLD (100), (120), (130) or other similar EECLD. In other words, in order for the PDU to be secured with an EECLD, one or more 3D connection elements of one must be compatible with one or more 3D connection elements of the other, unlike the prior art where an EECLD is simply placed in a recess of the PDU without securely locking.

In alternative embodiments of the PDU (550), the three-dimensional connection elements (514) can be of any shape so that they can be inserted and secured in the corresponding recesses of any EECLD. In other examples of implementation, the PDU (550) includes three-dimensional connection elements (514) of recess and/or protrusion type of the same or different shape and/or dimensions, which are located in the same or different surfaces of the PDU (550). Thanks to these three-dimensional connection elements (514), the same PDU (550) can be connected and secured to any type of EECLD. In variations of the above examples of implementation of the PDU (550), the PDU (550) can have any shape and dimensioning, which are obvious to persons with knowledge of the technical subject that do not create problems and incompatibilities in the connection and securing-locking of the PDU (550) with the respective EECLD.

Compatibility is defined as e.g. one or more three-dimensional connection elements of the PDU are of a protrusion type and one or more three-dimensional connection elements of each EECLD are of a recess type (or the inverse) and all three-dimensional connection elements have essentially the same dimensions and the same form-type-shape.

### Examples of Connection and Locking of a PDU With an EECLD

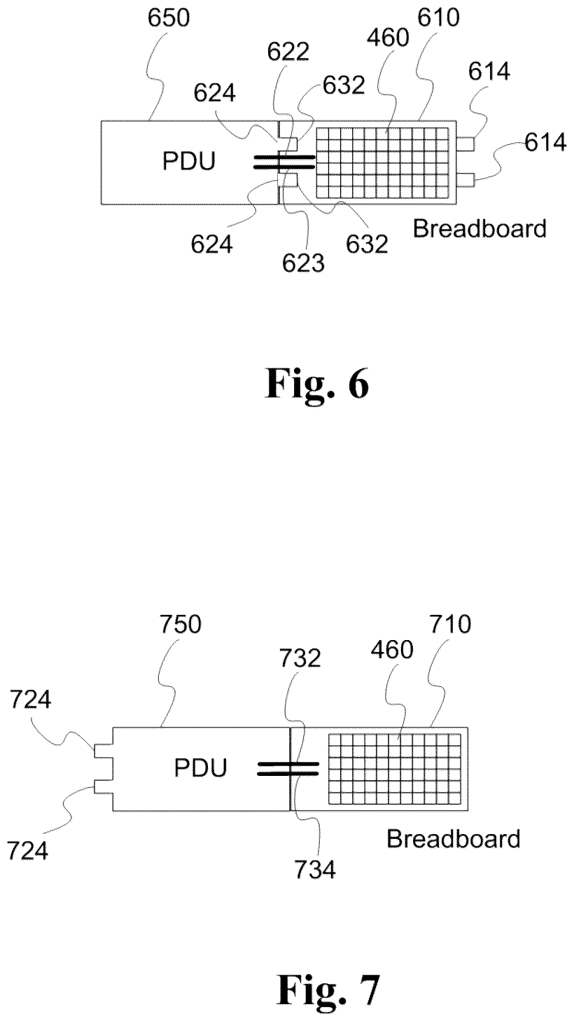

FIG 6. presents a first example of connecting and securing a PDU with an EECLD according to this innovative solution. PDU (650) has on one of its outer surfaces one or more three-dimensional protrusion-type connection elements (624) shaped and dimensioned so that they can be inserted and secured to the corresponding one or more recess-type three-dimensional connection elements (632) of the EECLD (610).

EECLD (610) carries on its other outer surface, parallel to the outer surface bearing the three-dimensional recess-type connection element (632), one or more projection-type three-dimensional connection elements (614). On an external surface perpendicular (along the z-axis) to that which carries the three-dimensional connection elements of the indentation and/or projection type (and which is defined by the x, y axes), the EECLD (610) has a matrix of cells (460), which is identical or equivalent to the prior art matrix (260). The connection of the PDU (650) to the EECLD (610) is made through cables or wires (622), (623) which ensure the supply of power from the PDU (650) to the EECLD (610). These cables or wires also perform a secondary function, that of locking the PDU (650) to the EECLD (610) which reinforces the robustness of the lock provided by the three-dimensional connecting elements and at the same time protects the three-dimensional connecting elements from stresses, could would at extreme intensity cause, at extreme situations, damage or even breakage of the three-dimensional connecting elements.

Preferably, to enhance the secondary locking function of the PDU (650) to the EECLD (610) provided by these cables or wires, the cables or wires are dimensioned and connected to the PDU (650) and the EECLD (610) in such a way that they exert dynamic tension and consequently keep the contacting surfaces of the PDU (650) and EECLD (610) in contact.

FIG. 7 shows a second example of connecting and securing a PDU with an EECLD according to the present innovative solution. PDU (750) has on its outer surface one or more three-dimensional protrusion-type connecting elements (724) shaped and dimensioned so that they can be inserted and secured to the corresponding one or more three-dimensional recess-type connecting elements in the EECLD. The PDU (750) does not bear on its other outer surface, parallel to the outer surface bearing the three-dimensional protrusion-type connecting element (724), any three-dimensional connecting element of any type. The PDU (750) is placed, with its outer surface not bearing a three-dimensional connection element, in contact with a surface of the EECLD (710), which surface of the EECLD (710) does not include any three-dimensional connection element of any type and is substantially perpendicular to the surface of the EECLD (710) which carries one or more boards with sockets for terminals of electronic components. The connection of the PDU (750) to the EECLD (710) is made through cables or wires (732), (734) which ensure the supply of power from the PDU (750) to the EECLD (710). As in the present second example of connecting and securing the PDU to the EECLD according to the present innovative solution, no three-dimensional connecting elements are used to secure the PDU (750) to the EECLD (710), the cables or wires (732), (734) are substituted for (to some extent) the locking function that would be performed by three-dimensional connecting elements, as in the first example of connecting and locking PDU with EECLD according to the present innovative solution. Therefore, the same PDU (650), (750) can ensure (even partial) locking with EECLD (610), (710), using different locking mechanisms, i.e. using three-dimensional connection elements or alternatively or additionally using cables or of wires (732), (734) which are used for power supply anyway.

Preferably, to enhance the secondary locking function of the PDU (750) with the EECLD (710) provided by the cables or wires (732), (734), the cables or wires (732), (734) are dimensioned and connected with the PDU (750) with the EECLD (710) in such a way that they exert dynamic tension and consequently keep the contacting surfaces of the PDU (750) and the EECLD (710) in contact.

On an outer surface perpendicular (along the z axis) to that tangent to the PDU (750) (and which is defined by the x, y axes), the EECLD (710) has a cell array (460) which is identical or corresponding to the table with sockets (260) of the state of the art.

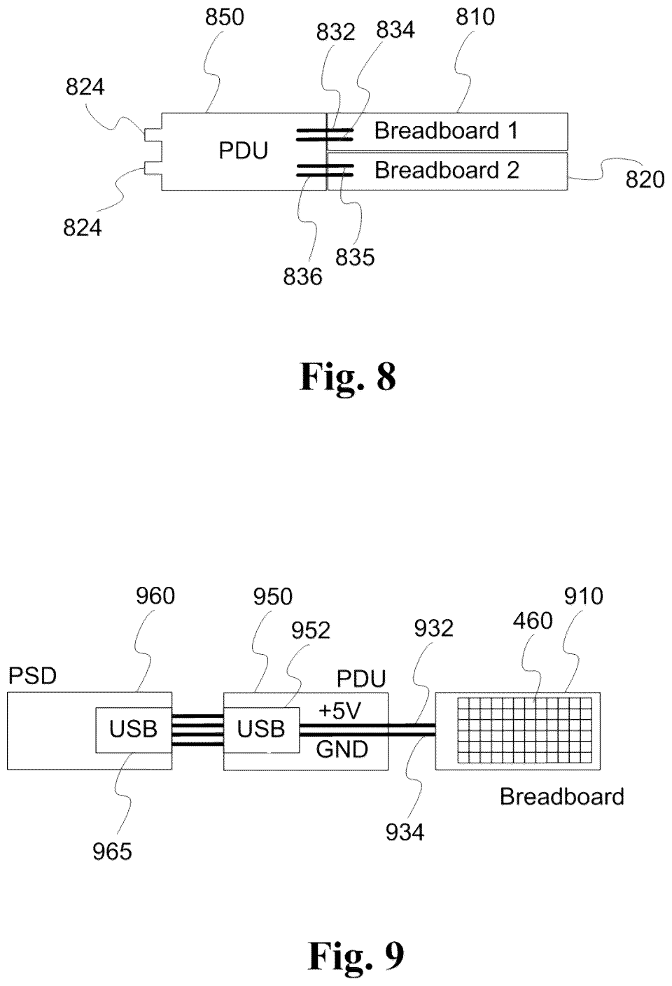

FIG. 8 shows a third example of connecting and securing PDU with EECLD according to this innovative solution. PDU (850) has on its outer surface one or more three-dimensional protrusion-type connecting elements (824) shaped and dimensioned so that they can be inserted and secured to the corresponding one or more three-dimensional recess-type connecting elements in the EECLD. The PDU (850) does not bear on its other outer surface, parallel to the outer surface bearing the three-dimensional protrusion-type connecting element (824), any three-dimensional connecting element of any type. The PDU (850) is placed, with its outer surface that does not have a three-dimensional connection element, in contact with a first surface of the EECLD (810) and with a second surface of the EECLD (820), which surfaces of the EECLD (810), (820) do not include no three-dimensional connection elements of any type and are substantially perpendicular to the surface of the EECLD (810) which carries one or more boards with sockets for electronic component terminals. The connection of the PDU (850) to the EECLD (810) is made through cables or wires (832), (834) and (835), (836), respectively, which ensure the supply of power from the PDU (850) to the EECLD (810), (820). As in the present second example of connection and securing of PDU with EECLD according to the present innovative solution no three-dimensional connection elements are used to secure the PDU (850) to the EECLD (810), (820), the cables or wires (832), (834) and (835), (836), respectively, replace (to some extent) the locking function that would be performed by three-dimensional connecting elements, as in the first example of connecting and locking PDU with EECLD according to the present innovative solution. Therefore, the same PDU (650), (750), (850) can ensure insurance with two EECLD (810), (820), using cables or wires (832), (834) and (835), (836), respectively, which are used for power supply anyway.

Preferably, to enhance the secondary locking function of the PDU (850) with the EECLDs (810), (820) provided by the cables or wires (832), (834) and (835), (836), the cables or wires (832), (834) and (835), (836) are dimensioned and connected to the PDU (850) and to the EECLDs (810), (820) in such a way that they exert dynamic tension and consequently hold in contact the contact surfaces of the PDU (850) and the EECLD (810), (820).

In a fourth example of connection and locking of PDU with EECLD according to the present innovative solution, the two EECLD (810), (820) include one or more recess-type three-dimensional connection elements and secure to them the corresponding one or more projection-type three-dimensional connection elements (824) of the PDU (850), which PDU (850) is rotated 180 degrees with respect to the illustration of Figure.8 so that the one or more of the three-dimensional connection elements (824) of the PDU (850) to come into contact with the surfaces of EECLD (810), (820) which carry the corresponding three-dimensional connection elements of the recess type and to secure.

The connection of the PDU (850) to the EECLD (810), (820) is made through cables or wires (832), (834) and (835), (836) which ensure the supply of power from the PDU (850) to EECLD (810), (820). These cables or wires also perform a secondary function, that of securing the PDU (850) to the EECLD (810), (820) which reinforces the robustness of the security provided by the 3D connecting elements, and at the same time protects the 3D connecting elements from stresses, which could in extreme magnitudes cause damage or even breakage of the three-dimensional connecting elements.

Preferably, to enhance the secondary locking function of the PDU (850) with the EECLDs (810), (820) provided by these cables or wires, the cables or wires are dimensioned and connected to the PDU (850) with the EECLDs (810), (820) in such a way that they exert dynamic tension and consequently keep the contact surfaces of the PDU (850) and the EECLD (810), (820) in contact.

In variations of the above examples of implementation of the PDU (550), the PDU (550) can have any shape and dimensions, which are obvious to persons with knowledge of the technical subject that do not create problems and incompatibilities in the connection and securing of the PDU (550) with the respective EECLD, such as for example indentations in the PDU and protrusions in the EECLD.

In the above embodiments, additional EECLDs can be connected to the PDU.

### Example of PDU Use

FIG. 9 shows an example of the implementation and use of PDU according to the present innovative solution. The PDU (950) includes a USB type connector (952) of any version or type (e.g. B, C, micro, etc.) for easy connection and power supply from any external Power Supply Device (PSD) (960) (such as a computer, smart phone, power bank, etc.), equipped with a USB connector (965) of any version and type which can be connected to the USB type connector (952) of the PDU (950). In one aspect, the USB type connector (952) of the PDU (950) is connected directly to the USB connector (965) of the external PSD (960), while in another aspect it is connected via a USB cable. Two conductive lines or cables or wires (932), (934) are connected to the USB-type socket (952) of the PDU (950), for the supply from the USB-type socket (952) of voltage +5V and ground (GND), respectively, to EECLD (910) which is connected to the PSD (960) in the manner described in the previous exemplary implementations for connecting and securing the PDU to the EECLD according to the present innovative solution.

The proposed solution, where the PDU (950) simply distributes the power (+5V voltage) it receives from the external PDU (960), allows the PDU (950) to be extremely simple, light and easy and cheap to manufacture as it does not contain heavy, complex or many electronic circuits (such as transformers, rectifiers, etc.). It simply includes the USB connector (952) and conductive lines or cables or wires (932), (934), which are contained in a box for protection, where the box includes one or more three-dimensional protrusion-type connection elements as described in the previous examples.

Connecting the PDU (950) with a USB connector (965) to a corresponding USB connector of an external PSD ensures that the external PSD (as it follows the USB standard) provides constant voltage and overvoltage protection and consequently the PSD (950) does not need to include additional voltage transformation and stabilization and overvoltage protection circuits.

With this design, the PDU (950) facilitates the use of EECLD in the field and elsewhere, is suitable for use with any type of EECLD, provides secure locking of at least one EECLD with the PDU, is easy and cheap to manufacture, and at the same time is protected and durable to avoid possible damage to it. Therefore, the proposed PDU (950) solves all the problems set out above.

### Example of Alternative PDU Implementation—With Voltage Selector

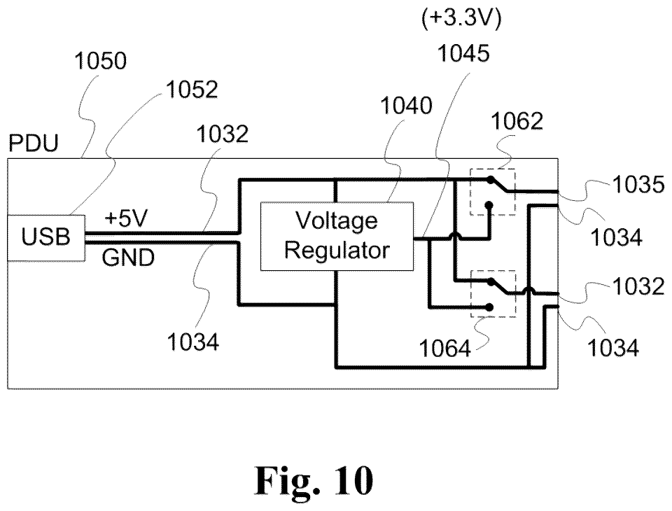

FIG. 10 shows an example of an alternative PDU implementation, which includes a voltage selector. The PDU (1050) includes a USB type connector (1052) of any version and type (e.g. B, C, micro, etc.) for easy connection and power supply from any External PSD.

Two conductive lines (or cables or wires) (1032), (1034) are connected to the USB socket (1052) of the PDU (1050), for the supply of +5V voltage and ground (GND) from the USB socket (1052). Between the two conductive lines (1032), (1034) a voltage regulator (1040) is connected which produces at its output a new voltage (e.g. +3.3V), different from the voltage of +5V, and the new voltage is fed into a conductive line (1045). The conductive lines (1032), (1034), (1035) are then connected to a first (1062) and a second (1064) voltage selector through which voltage selectors (1062), (1064) the user of the PDU (1050) can select the desired voltage and channel it to the output of the PDU (1050).

In modifications of the present exemplary alternative PDU embodiment, the two voltage selectors (1062), (1064) may be replaced by a single multiple voltage selector, or more voltage regulators and/or voltage selectors may be added so that the user of the PDU can select more voltages, or the voltage selectors to be replaced by corresponding cable or wire sockets to which the cables or wires (1032), (1034) and (1035) connecting the PDU to one or more EECLDs are selectively connected.

Alternative implementations of the present PDU include the use of a voltage regulator without the use of a voltage selector. In these alternative implementations, e.g. from the 5V provided by the USB socket, the voltage regulator produces e.g. 3.3 V and supplies the EECLD with 3.3 V. In another implementation example, the PDU supplies with 5V a first power line of the EECLD and with 3.3V a second power line of the same EECLD, without the use of a voltage selector.

In a modification of the present example of an alternative PDU implementation, the PDU can receive from an external device, through the USB connector, 5V according to the USB standard. Alternatively or additionally, the PDU can receive from an external device, through the USB socket, other voltages (e.g. 9V) using the protocol (and the corresponding subsystem in a compatible external device) USB Power Delivery (USB-PD).

In further modifications of the present example of an alternative PDU embodiment, the PDU may include more voltage regulators, a dimmer, a voltmeter, an ammeter, for better regulation and monitoring of the operating parameters of the EECLD, and/or a battery to enable the use of the PDU in the field without the need to provide USB power from an external PSD.

In example embodiments where the EECLD includes a battery, the EECLD may also include one or more USB outputs (of the same or different types), combined with suitable circuitry, thus allowing the device to also function as a powerbank.

In all the implementation examples presented above, the PDU can carry one or more USB sockets of a different type each. It can also carry, in addition to one or more USB sockets, sockets for plugs or plugs suitable for supplying power from power sources alternative to the sources that provide a USB connection. In this case it is up to the user of the PDU to ensure that the alternative power source provides protection against overvoltage etc.

All voltages (i.e. potential differences) mentioned in this description are for direct current (DC).

The examples used above to describe the present innovative solution should not be considered as limiting the scope of the present innovative solution. The present innovative solution can be applied in other scenarios and settings than those described in the examples presented above.

The average person skilled in the art will understand that the number, distribution, shape, proportions and dimensions of the parts of the present invention, as shown in the exemplary embodiments, may be modified without departing from the scope and intended protection of the present invention.

The above descriptions of exemplary embodiments are simplified and do not include parts that are used in the embodiment but are not part of the present invention, are not necessary to the understanding of the invention and are obvious to an average person with relevant knowledge of the art related to the invention. In addition, variations of the exemplary embodiments are possible where, for example, certain elements of the exemplary embodiments may be rearranged, omitted and replaced with equivalents or new ones may be added, and existing elements may be interconnected in a manner different from that described, with the condition that the different wiring is compatible with the technical effect that the elements of the invention have, being technical characteristics of the invention. Likewise, modification of the shape and dimensions of the shown parts is considered to be within the scope of protection of the present invention to the extent that such modifications are obvious to persons skilled in the relevant art and to the extent that such modifications are equivalent to the exemplary embodiments presented or do not add tangible and unexpected or non-obvious improvements to the technical result they offer. Thus, the present text is not intended to be limited only to the exemplary embodiments of the invention presented but is to be given the widest possible scope in accordance with the principles and novel features it discloses.

Unless otherwise specifically stated, it is the intention of the inventor to give to the words and phrases mentioned in the description of the invention and the claims the ordinary and generally accepted meanings attributed to the average person with relevant knowledge of the related art with the present invention.

The foregoing description of a preferred embodiment and best mode of carrying out the invention known to the applicant at the time of filing has been presented and is intended for the purposes of illustration and description. It is not intended to be exhaustive or to limit the invention to the precise form disclosed and many modifications and variations are possible in light of the above teachings. The embodiment has been selected and described to better explain the principles of the invention and its practical application and to enable others skilled in the art to better utilize the invention in various application scenarios and modes of use and with various modifications as are appropriate to the specific use under consideration. Therefore, it is intended that the invention is not limited only to the specific details disclosed for carrying out the invention, but that the invention includes everything that falls within the scope of the appended claims.

1.-10. (canceled)

11. A self-locking portable power distributor for breadboards, comprising:
a power output including two conductive lines configured for supplying voltage and ground to at least one breadboard;
a power input including a Universal Serial Bus (USB) connector, the USB connector being located either (a) on a second external surface of the distributor that is parallel to a first external surface of the distributor, or (b) on a third external surface of the distributor that is perpendicular to both the first and the second external surfaces of the distributor and configured to be perpendicular to a second outer surface of the breadboard when the breadboard is secured to the distributor, wherein the USB connector is configured for providing voltage and ground to the output of the distributor and for receiving voltage and ground from an external power supply device; and
at least one three-dimensional connection element located on the first external surface of the distributor, wherein the three-dimensional connection element of the distributor is shaped and dimensioned to be compatible with at least one three-dimensional connection element of the breadboard, the three-dimensional connection element of the breadboard being located on a first outer surface of the breadboard, wherein the first outer surface of the breadboard is substantially perpendicular to the second outer surface of the breadboard;
wherein the second outer surface of the breadboard carries at least one electronic component terminal socket;
wherein the at least one three-dimensional connection element of the distributor is configured for engaging with the at least one three-dimensional connection element of the breadboard to allow side-to-side connection of the distributor to the breadboard with respect to the at least one electronic component terminal socket; and
wherein (a) the at least one three-dimensional connection element of the distributor is a protrusion-type element and the at least one three-dimensional connection element of the breadboard is a recess-type element, both configured to secure the breadboard to the distributor when the at least one protrusion-type element is fully inserted into the at least one recess-type element, or (b) the at least one three-dimensional connection element of the distributor is a recess-type element and the at least one three-dimensional connection element of the breadboard is a protrusion-type element, both configured to secure the breadboard to the distributor when the at least one protrusion-type element is fully inserted into the at least one recess-type element.

12. The self-locking portable power distributor of claim 11, wherein the USB connector is selected from the group consisting of: type B, type C, and micro USB.

13. The self-locking portable power distributor of claim 12, wherein the at least one three-dimensional connection element of the distributor has a shape selected from the group consisting of: square, parallelogram, triangular, prismatic, and cylindrical cross-section.

14. The self-locking portable power distributor of claim 11, wherein the at least one three-dimensional connection element of the distributor has a shape selected from the group consisting of: square, parallelogram, triangular, prismatic, and cylindrical cross-section.

15. The self-locking portable power distributor of claim 14, further comprising at least one of:
a voltage regulator;
a voltage selector;
a dimmer switch;
a voltmeter;
an ammeter; and
a battery.

16. The self-locking portable power distributor of claim 13, further comprising at least one of:
a voltage regulator;
a voltage selector;
a dimmer switch;
a voltmeter;
an ammeter; and
a battery.

17. The self-locking portable power distributor of claim 12, further comprising at least one of:
a voltage regulator;
a voltage selector;
a dimmer switch;
a voltmeter;
an ammeter; and
a battery.

18. The self-locking portable power distributor of claim 11, further comprising at least one of:
a voltage regulator;
a voltage selector;
a dimmer switch;
a voltmeter;
an ammeter; and
a battery.

19. The self-locking portable power distributor of claim 18, wherein the USB connector comprises at least one USB connector.

20. The self-locking portable power distributor of claim 17, wherein the USB connector comprises at least one USB connector.

21. The self-locking portable power distributor of claim 16, wherein the USB connector comprises at least one USB connector.

22. The self-locking portable power distributor of claim 15, wherein the USB connector comprises at least one USB connector.

23. The self-locking portable power distributor of claim 14, wherein the USB connector comprises at least one USB connector.

24. The self-locking portable power distributor of claim 13, wherein the USB connector comprises at least one USB connector.

25. The self-locking portable power distributor of claim 12, wherein the USB connector comprises at least one USB connector.

26. The self-locking portable power distributor of claim 11, wherein the USB connector comprises at least one USB connector.

27. The self-locking portable power distributor of claim 26, wherein the distributor includes a battery and at least one USB connector.

28. The self-locking portable power distributor of claim 1, wherein the distributor includes a battery and at least one USB connector.

29. A method for supplying power to at least one breadboard, the method comprising:
securing a self-locking portable power distributor to the at least one breadboard by fully inserting and locking side-by-side at least one three-dimensional connection element of the distributor with at least one three-dimensional connection element of the breadboard, the at least one three-dimensional connection element of the distributor being compatible with the at least one three-dimensional connection element of the breadboard;
connecting a power output of the distributor to the at least one breadboard via a first cable for supplying voltage and a second cable for providing ground from the distributor to the breadboard; and
connecting a power input of the distributor, via a USB connector of the distributor, to a USB connector of an external power supply device to provide a first voltage and ground from the external power supply device to the distributor.

30. The method of claim 29, further comprising selecting at least one second voltage to supply to the breadboard by using:
at least one voltage selector of the distributor, wherein the voltage selector selects the second voltage and routes it to the output of the distributor, and the second voltage is produced by at least one voltage regulator of the distributor; or
at least one voltage regulator, the output of which is directly connected to the output of the distributor; or
a USB Power Delivery protocol, wherein the protocol enables the distributor to receive the second voltage from the external power supply device and distribute it to at least one power output of the distributor; or
a USB Power Delivery protocol, wherein the protocol enables the distributor to receive the second voltage from the external power supply device and generate at least one third voltage and distribute the third voltage to at least one power output of the distributor.
